(19) United States
(12) Patent Application Publication
(10) Pub. No.: US 2006/0029632 A1
(43) Pub. Date: Feb. 9, 2006

(54) Insecticides and arachnicides

(75) Inventor: Joseph Howard Henshaw, Nicosia (CY)

Correspondence Address: LADAS & PARRY, 26 WEST 61ST STREET, NEW YORK, NY, 10023, US

(73) Assignee: NATROCELL TECHNOLOGIES LTD.

(21) Appl. No.: 11/237,044

(22) Filed: Sep. 28, 2005

Related U.S. Application Data
(62) Division of application No. 10/429,284, filed on May 2, 2003.

(30) Foreign Application Priority Data
May 3, 2002 (GB) 0210260.6

(51) Int. Cl. A01N 25/08; A01N 65/00

(52) U.S. Cl. 424/410; 424/750; 424/757

(57) ABSTRACT

A non-toxic insecticide or arachnicide comprises insecticide or arachnicide in finely divided form comprising: a) insecticidal or arachnicidal cellulosic material obtainable from the core of corncobs, and b) optionally an attractant, said cellulosic material interfering with the digestion of insects or arachnids and said insecticide or arachnicide being non-toxic to humans and is produced in finely divided form (e.g. particle size predominantly below 700 micrometres preferably 200 to 500 micrometres) so as to be carryable by the targeted insect (e.g. ants) or to collect on the exterior of the insect (e.g. the legs of a cockroach). Preferably the cellulosic material is obtainable from the core of corncobs of maize (corn) descended from any of the hybrids DK 446, DK 401, DK 442, DK 512, DK 560, DK 588, DK 591, DK 604, DK 628, DK 634 and DK 512 wx.

The present invention relates to insecticides and arachnicides which are non-toxic to human beings, domestic animals and livestock.

In our granted patent GB 2,311,464B it is disclosed that the cellulosic material obtainable from the core of the cob of a certain hybrid of maize (Zea mays, known as corn in the USA) is toxic to rodents but not to humans.

This hybrid is known as DK 446 and is obtainable from Dekalb Plant Genetics (3100 Sycamore Rd, DeKalb, Ill. 60115 USA). It normally grows to a height of 2.7 to 3.3 metres (9 to 11 feet) and normally has a single giant ear of corn. It is commonly grown for use as cattle feed.

The cellulosic material obtained from the core of the cob of the above hybrid has been analysed and has been found to consist of essentially pure alpha cellulose, which is the naturally occurring form of cellulose. Alpha cellulose is generally recognised as a safe food additive with essentially no toxicity to humans and domestic animals.

It is believed that the different effects on rodents and humans are due to their different digestive systems, although there is some uncertainty about the precise mode of action of the above rodenticidal material.

The above patent teaches that the rodenticide should preferably be pelletised, the pellets having a diameter of 4 to 12 mm, preferably 10 mm and a length of eg 10 to 30 mm. Such pellets are not effective against small, non-mammalian pests such as insects and arachnids.

U.S. Pat. No. 5,186,935 teaches that non-toxic insecticidal compositions comprising diatomaceous silica and/or clamshells kill insects by scratching through the protective waxylayer, resulting in desiccation and dehydration. When such particles are injested by the insect, death is accelerated by internal desiccation. The silica and/or clamshells are crushed to a particle size of less than 45 micrometres and coated with an attractant of honey and yeast.

U.S. Pat. No. 6,136,340 and also WO 97/02741 and WO97/02743 disclose toxicant-free bait powder for insects such as ants, consisting essentially of spent grain reduced to particulate form. The spent grain is derived from corncobs by removing the core. No supporting data is given, no details of the mode of action are given and no details of the corn or the particle size are given.

It has now been found that the cellulosic material of GB 2,311,464B is also effective for the control of insects and arachnids when prepared in finely divided form and optionally combined with an appropriate bait attractant.

Accordingly the invention provides an insecticide or arachnicide in finely divided form comprising:
a) insecticidal or arachnicidal cellulosic material obtainable from corncobs, and
b) optionally an attractant,
   said cellulosic material interfering with the digestion of insects or arachnids and said insecticide or arachnicide being non-toxic to humans.

In another aspect the invention provides a method of alleviating insect or arachnid infestation comprising depositing in the region of infestation an insecticide or arachnicide as defined above.

The above cellulosic material mainly comprises alpha cellulose. A suitable commercial source is “Grit-O-Cobs” as supplied by The Andersons Inc., Ohio, United States of America.

The mode of mortality against insects and arachnids, while not yet fully clarified, is believed to be physical in nature: it is envisaged that the alpha cellulose interferes with the digestive system of the pest and prevents it from obtaining nourishment.

Because the above pesticidal material is not harmful to humans, livestock or domestic animals the invention has great advantages in terms of safety and compatibility with the environment.

Pests which it is envisaged could be controlled by the compositions of the invention include colonial insects of the order Hymenoptera, family Formicidae (which includes numerous species of ants), and insects of the order isoptera, family Termitidae (which includes termites).

In particular the compositions of the invention are envisaged for the control of the following species of ants:
Argentine ant—Iridomyrmex humilis
Big-headed ant—Pheidole megaoephala
Black carpenter ant—Camponotus pennsylvanicus
Black imported fire ant—Solenopsis richteri
Brown carpenter ant—Camponotus castaneus
Cornfield ant—Lasius alienus
Florida carpenter ant—Camponotus abdominalis floridanus
Imported fire ant—Solenopsis geminata
Large yellow ant—Acanthomyops intejectus
Leaf cutter ant—Atta cephalotex
Leaf cutter ant—Atta sexdens
Little black ant—Monomonium minimum
(no common name)—Acromyrmex sp.
Odorous house ant—Tapinoma sessile
Pavement ant—Tetramorium caespitum
Pharaoh ant—Monomorium pharaonis
Red carpenter ant—Camponotus ferrugineus
Red imported fire ant—Solenopsis invicta
Small yellow ant—Acanthomyops clavige
Southern fire ant—Solenopsis xyloni
Texas leaf-cutting ant—Atta texana
Thief ant—Solenopsis molesta

In particular the compositions of the invention are envisaged for the control of the following species of termites:
Arid-land subterranean termite—Reticulitermes tibialis
Common dry-wood termite—Kelotermes minor
Damp-wood termite—Paraneotennes simplicomis
Dry-wood termit—Criptotermes brevis
Dry-wood termite—Criptotermes rospigliosi
Dry-wood termite—Kalotermes schwartzi
Eastern subterranean termite—Reticulitermes flavipes
Formosan subterranean termite—Coptotermes formosanus
(no common name)—Ancistrotermes carithorax
(no common name)—Microtermes subhyalinus
Pacific damp-wood termite—Zootermopsis angusticollis
Southeastern dry-wood termite—Kalotermes snyderi
Southern dry-wood termite—Kalotermes hubbardi
Subterranean termite—Coptotermes testaceous
Subterranean termite—Heterotermes tenuis
Subterranean termite—Rhinotennes nasutus
Tree termite—Nasutitermes sp
Western dry-wood termite—Incisitennes minor
Western subterranean termite—Retculitermes hesperus

An attractant which has been found particularly suitable for ants is carob oil or a volatile terpene component thereof. No added attractant is needed for termites.

Accordingly one ant bait in accordance with the present invention comprises insecticidal or arachnicidal cellulosic material as defined above (but preferably the woody ring material obtainable from the DK 446 hybrid or a descendant thereof impregnated with a volatile terpene component of carob oil.

The insecticide or arachnicide can for example be deposited in or near colonies of the ants, termites or other colonial insects or in the path of an ant trail for example or can be distributed (preferably uniformly) on infested pastureland or cropland land or on the floor of infested buildings for example. The dosage is not critical and in general the optimum dosage can be determined by routine experimentation. The amount of pesticide needed to eradicate a colony will vary with factors such as the identity of the pest, the size of the colony, and other factors.

It is envisaged that other species of ants and termites and indeed other families of colonial insects eg wasps are also susceptible to the composition of the invention.

Another embodiment of the invention is suitable for the control of cockroaches, in particular the following species:
American cockroach—Periplaneta americana
Brown-banded cockroach—Supella longipalpis
German cockroach—Blattella germanica
Oriental cockroach—Blatta onentals
Smoky-brown cockroach—Periplaneta fuliginosa
Oriental cockroach—Blatta orentalis
Brownbanded cockroach—Supella longipalpa
Woods cockroach—Parcoblatta spp.
Australian cockroach—Periplaneta australasiae
Brown cockroach—Periplaneta brunnea
Asian cockroach—Blattelle asahinai Mizukobo
Surinam cockroach—pycnoscelus surinamensis
Florida Woods cockroach—Eundotis floridana

Cockroaches remain one of the most widespread and troublesome household and commercial pests, in spite of the extensive use of insecticides, and German cockroaches in particular are responsible for the transmission of disease and are commonly found indoors. Hence the use of toxic compositions is undesirable.

An attractant which has been found particularly suitable for cockroaches is fish meal or a volatile amine component thereof.

Accordingly one cockroach insecticide in accordance with the present invention comprises cellulosic material as defined above (but preferably the white core material obtainable from the DK 446 hybrid or a descendant thereof) impregnated with a fishy amine.

The cockroach insecticide can be applied uniformly as a thick (eg 5 mm or greater) dust on the floors of infested buildings or can be deposited around the perimeter of the floor of an infested room eg to a depth of 20 to 30 mm where it is particularly effective because cockroaches normally prefer to follow a peripheral path.

Other pests which, it is envisaged, could be controlled by composition in accordance with the invention include both insects and arachnids. Including fleas, mites including spider mites and gall mites ticks, mosquitos, aphids and thrips for example.

Because the composition of the invention is in finely divided form (eg a powder) either it tends to collect on the surface of eg the legs of larger insects such as cockroaches, prompting the affected insect to remove the insecticide by eating it, or, particularly in the case of colonial pests such as ants and termites, individual grains are picked up and carried back to the colony (eg by worker ants) and shared with other inhabitants of the colony, a process known as trophallaxis. Because the insecticide of the invention takes effect only gradually it can be widely distributed within the colony before killing the insects.

Preferably the particle size range of the insecticide is selected to suit the species being targeted and can be determined experimentally and/or by reference to the known physiology of the species, in particular the carrying and eating capacity of the workers, for example.

Thus a particle size range of 80/60 (ie predominantly 180 micrometres to 250 micrometres) is suitable for brown and black ants because particles of this size are large enough to be picked up by worker ants of these species but not too large to be eaten, whereas a particle size range of 60/40 (ie predominantly 425 to 260 micrometres) is more suitable for pharaoh ants.

As will be understood by persons skilled in the art of powder preparation, a particle size range of ‘A/B’means particles capable of passing through a US Standard Sieve of mesh ‘A’ but not capable of passing through a US Standard Sieve of mesh ‘B’. The different US Standard Sieves have respective opening sizes which can be looked up in standard tables.

A particle size range of 80/60 (ie predominantly 180 micrometres to 250 micrometres) is suitable for cockroaches because such particles are small enough to collect on the legs of cockroaches but sufficiently large to have a significant effect on their digestive system.

Other hybrids similar to the above DK 446 hybrid (especially maize hybrids characterised by normally growing to a height of 2.7 to 3.3 metres (9 to 11 feet) and by normally having a single giant ear of corn) are envisaged to be useful sources of identical or similar cellulosic pesticidal material which is also usable in compositions in accordance with the inversion. Furthermore hybrids DK 401, DK 442, DK 512, DK 560, DK 588, DK 591, DK 604, OK 628, OK 634 and DK 512wx, or descendants thereof, all obtainable from Dekalb Plant Genetics, are envisaged to be useful sources of identical or similar pesticidal material.

Preferably the attractant, if present, is a natural product or is derived from a natural product. In certain embodiments the attractant can be a semiochemical (ie a chemical that mediates an (in this case attractant) interspecific or intraspecific interaction involving the targeted pest) and is preferably a pheromone. Such embodiments have the advantage over conventional compositions involving synthetic (and somewhat volable) chemical toxic agents that cellulose is inert and odourless and does not interfere with the effect of the semiochemical.

The insecticide or arachnicide can be made by bringing into association a) a pest attractant b) said cellulosic material.

Preferably the cellulosic material is reduced to a finely divided form With a range of particle sizes selected to optimise ingestion by the targeted insect or arachnid. For example the particle sizes can be predominantly less than 700 micrometres (preferably less than 500 micrometres) and predominantly greater than 100 micrometres (preferably greater than 200 micrometres).

The invention extends to compositions comprising any of the cellulosic insecticidal or arachnicidal materials identified above (particularly alpha celluloses), whether synthetic or obtained from natural sources.

Preferred embodiments of the invention are described below in the following non-limiting examples.

### EXAMPLE 1

### Ant Bait

Woody ring material from the DK 446 hybrid (obtained from the hybrid by the method disclosed in GB 2,311,464B) was classified to an 80/60 size range (ie predominantly 180 micrometres to 250 micrometres particle sizes) and mixed in a 1:1 weight ratio with Carob seeds (commercially available as an animal feed and obtainable from the pod of the Carob tree Ceratonia siliqua) and tumbled for 15 minutes in an airtight stainless steel drum. The tumbling procedure was repeated daily for four days and the product was then sifted to separate the white core material (now impregnated with carob oil from the carob seeds) from the carob seeds.

The impregnated white core material was deposited in a colony of black sweet ants and it was observed that the worker ants carried off grains of the material to the remaining ants in the colony. The colony was eradicated in three days.

The product could be stored in triple-ply paper bags having a plastic liner (150 pound bursting strength) without loss of efficacy.

### EXAMPLE 2

### Termite Bait

Woody ring material from the DK 446 hybrid (obtained from the hybrid by the method disclosed in GB 2,311,464B) was classified to an 60/40 size range (ie predominantly 250 micrometres to 425 micrometres particle sizes). Two kilograms of the finely divided cellulosic material was deposited in a colony of termites (after removing the top of the colony with a pickaxe to provide access)and it was observed that the soldier termites carried off grains of the material to the remaining termites in the colony. The colony was eradicated in three days.

The product could be stored in triple-ply paper bags having a plastic liner (150 pound bursting strength) without loss of efficacy.

### EXAMPLE 3

### Cockroach Bait

Woody ring material from the DK 446 hybrid (obtained tom the hybrid by the method disclosed in GB 2,311,464B) was classified to an 80/60 size range (ie predominantly 180 micrometres to 250 micrometres particle sizes) mixed in a 5:1 weight ratio with commercially available fish bone meal and tumbled for 15 minutes in an airtight stainless steel drum. The tumbling procedure was repeated daily for five days and the resulting product was deposited in a region of cockroach infestation The infestation was eradicated in 24 hours.

The product could be stored in triple-ply paper bags having a plastic liner (150 pound bursting strength) without loss of efficacy.

1. A method of alleviating insect or arachnid infestation comprising depositing in the region of infestation an-insecticide or arachnicide in finely divided form that can be picked up by targeted insects or arachnids and comprising:
a) insecticidal or arachnicidal cellulosic material obtainable from corncobs, and
b) optionally an attractant,
said cellulosic material interfering with the digestion of insects or arachnids and said insecticide or arachnicide being non-toxic to humans.

2. A method according to claim 1 wherein the particle sizes of the insecticide or arachnicide are such as to enable targeted insects or arachnids to carry the insecticide or arachnicide particles to others of the targeted insects or arachnids.

3. A method according to claim 1 wherein said cellulosic material is obtainable from corncobs of hybridized corn.

4. An insecticide or arachnicide according to claim 3 wherein said hybridized corn is descended from any of the hybrids DK 446, DK 401, DK 442, DK 512, DK 560, DK 588, DK 591, DK 604, DK 628, DK 634 and DK 512 wx.

5. A method according to claim 1 wherein said attractant is selected from the group consisting of carob oil and a volatile terpene component of carob oil.

6. A method according to claim 1 wherein the targeted insects are cockroaches.

7. A method according to claim 6 wherein said attractant is selected from the group consisting of fish meal and a volatile amine component of fish meal.

8. A method according to claim 1 wherein the targeted insects are selected from the group consisting of cockroaches, black ants and brown ants and the insecticide has a particle size range of 80/60.

9. A method according to claim 1 wherein the targeted insects are pharaoh ants and the insecticide has a particle size range of 60/40.

10. A method according to claim 1 where the particles are small enough to collect on the exterior of the targeted insect or arachnid but sufficiently large to affect their digestive systems.

11. A method according to claim 1 wherein the insecticide or arachnicide is deposited within a building used by human beings.
